(19) United States
(12) Patent Application Publication
(10) Pub. No.: US 2011/0178823 A1
(43) Pub. Date: Jul. 21, 2011

(54) DEFRAYING TAXES ON CONVERSION OF TRADITIONAL INDIVIDUAL RETIREMENT ACCOUNT TO A ROTH INDIVIDUAL RETIREMENT ACCOUNT

(76) Inventor: Phillip R. Wasserman, Sarasota, FL (US)

(21) Appl. No.: 12/688,641

(22) Filed: Jan. 15, 2010

(51) Int. Cl. G06Q 40/00

(52) U.S. Cl. 705/4; 705/37; 705/36 T

(57) ABSTRACT

A method for defraying taxes on conversion of a traditional IRA to a Roth IRA is disclosed. The method includes selling the holdings of the traditional IRA, purchasing a bonus annuity with proceeds of the sale of the holdings, designating the bonus annuity as a Roth IRA, waiting for a period of time, withdrawing from the bonus annuity a first amount slated for paying taxes on the conversion, waiting for a period of time, withdrawing from the bonus annuity a second amount, paying at least a portion of taxes on the conversion with the first and second amounts, waiting for a period of time, withdrawing from the bonus annuity a third amount, and paying substantially a remainder of the taxes on the conversion with a remaining portion of the first, second and third amounts, wherein a sum of the first, second and third amounts equal the taxes on the conversion.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of taxes and more specifically to the field of taxes pertaining to individual retirement accounts.

### BACKGROUND OF THE INVENTION

A traditional individual retirement account (IRA) is an account that, under the United States federal tax law, allows individuals to direct pretax income, up to specific annual limits, toward investments that can grow tax-deferred. That is, capital gains and dividend income are not taxed in a traditional IRA. Individual taxpayers are allowed to contribute 100% of compensation up to a specified maximum dollar amount to their traditional IRA. Contributions to the traditional IRA may be tax-deductible depending on various factors, such as the taxpayer's income, tax-filing status and other factors. Traditional IRAs are held by custodians, such as commercial banks and retail brokers, and investors can place IRA funds into stocks, bonds, funds, and other financial assets deemed fit by the custodian.

When the owner of a traditional IRA begins to receive distributions from the IRA, usually upon retirement, the income is treated as ordinary income and may be subjected to regular income tax. This differs from the Roth IRA, which can offer tax-free distributions from the Roth IRA upon retirement. A Roth IRA bears many similarities to the traditional IRA, but contributions are not tax deductible and qualified distributions are tax free. A qualified distribution is one that is taken at least five years after the taxpayer establishes his or her first Roth IRA and when he or she reaches a certain age, becomes disabled, uses the withdrawal to purchase a first home, or dies (in which case the beneficiary collects). Since qualified distributions from a Roth IRA are always tax free, some argue that a Roth IRA may be more advantageous than a traditional IRA. For this reason, converting a traditional IRA to a Roth IRA has become popular among investors.

One of the problems with converting a traditional IRA to a Roth IRA, however, is the tax the investor must pay on the amount being converted. Since contributions made into a traditional IRA are made pre-tax, and the distributions from the Roth IRA are generally tax-free, the investor must pay ordinary federal income tax on the taxable amount that is converted from a traditional IRA to a Roth IRA. If the investor does not have the income tax amount handy when the conversion occurs, the income tax must be subtracted from the converted amount, thereby reducing the size of the IRA. Otherwise, the investor pays the income tax amount out-of-pocket from regular income or from personal savings when the conversion occurs. Either way, the aforementioned tax implications make the traditional-to-Roth conversion unpalatable to many investors.

Therefore, a need exists to overcome the problems with the prior art as discussed above, and particularly for a more efficient way of defraying the taxes encountered when converting a traditional IRA to a Roth IRA.

### SUMMARY OF THE INVENTION

Briefly, according to an embodiment of the present invention, a method for defraying taxes on conversion of a traditional IRA to a Roth IRA is disclosed. The method includes selling the holdings of the traditional IRA, purchasing a bonus annuity with proceeds of the sale of the holdings, designating the bonus annuity as a Roth IRA, waiting for a period of time, withdrawing from the bonus annuity a first amount slated for paying taxes on the conversion, waiting for a period of time, withdrawing from the bonus annuity a second amount, paying at least a portion of taxes on the conversion with the first and second amounts, waiting for a period of time, withdrawing from the bonus annuity a third amount, and paying substantially a remainder of the taxes on the conversion with a remaining portion of the first, second and third amounts, wherein a sum of the first, second and third amounts substantially equal the taxes on the conversion.

In another embodiment of the present invention, a computer system for defraying taxes on conversion of a traditional IRA to a Roth IRA is disclosed. The computer system includes a processor configured for selling the holdings of the traditional IRA, purchasing a bonus annuity with proceeds of the sale of the holdings, designating the bonus annuity as a Roth IRA, waiting for a period of time, withdrawing from the bonus annuity a first amount slated for paying taxes on the conversion, waiting for a period of time, withdrawing from the bonus annuity a second amount, paying at least a portion of taxes on the conversion with the first and second amounts, waiting for a period of time, withdrawing from the bonus annuity a third amount, and paying substantially a remainder of the taxes on the conversion with a remaining portion of the first, second and third amounts, wherein a sum of the first, second and third amounts substantially equal the taxes on the conversion.

In another embodiment of the present invention, a computer program product comprising computer instructions for defraying taxes on conversion of a traditional IRA to a Roth IRA is disclosed. The computer instructions includes instructions for selling the holdings of the traditional IRA, purchasing a bonus annuity with proceeds of the sale of the holdings, designating the bonus annuity as a Roth IRA, waiting for a period of time, withdrawing from the bonus annuity a first amount slated for paying taxes on the conversion, waiting for a period of time, withdrawing from the bonus annuity a second amount, paying at least a portion of taxes on the conversion with the first and second amounts, waiting for a period of time, withdrawing from the bonus annuity a third amount, and paying substantially a remainder of the taxes on the conversion with a remaining portion of the first, second and third amounts, wherein a sum of the first, second and third amounts substantially equal the taxes on the conversion.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is a flowchart showing the overall control flow of the IRA conversion process of one embodiment of the present invention.

FIG. 2 is a block diagram describing an automated system useful for implementing one embodiment of the present invention.

FIG. 3 is an information processing system useful for implementing the processes of one embodiment of the present invention.

### DETAILED DESCRIPTION

Briefly, according to an embodiment of the present invention, a method, computer system and computer program product for defraying taxes on conversion of a traditional IRA to a Roth IRA are disclosed. The present invention addresses the deficiencies of the prior art by providing a method for defraying taxes on a traditional-to-Roth conversion, without significantly reducing the principal of the IRA or utilizing significant out-pocket monies from regular income or personal savings. Specifically, the present invention combines the benefits of a new U.S. law and the advantages of a bonus annuity to automatically pay all or substantially all of the taxes on a traditional-to-Roth conversion, thereby effectuating an easy and seamless conversion process. Taxes on the conversion of a traditional IRA to a Roth IRA are paid from the bonus provided by a bonus annuity and potentially from earnings of the bonus annuity. The present invention is advantageous because it allows an investor to significantly maintain the size of the principal of the IRA during conversion without requiring the investor to outlay significant out-of-pocket monies, thereby making the traditional-to-Roth conversion more palatable to the investor.

The passing into law of the Tax Increase Prevention and Reconciliation Act (TIPRA) of 2005 inspired the present invention. In the United States, TIPRA changed various aspects of tax law. One such change enacted by TIPRA allowed more taxpayers to convert from a traditional IRA to a Roth IRA by removing the modified adjusted gross income limitation on such rollovers starting in 2010. Another such change enacted by TIPRA allows taxpayers who effectuate a conversion from a traditional IRA to a Roth IRA in 2010 to pay taxes on the conversion over the following two years. This change allows the tax implication of a traditional-Roth conversion to be spread out over two years. As a result, as of 2010, under the tax laws in place in the United States, an investor need not pay conversion taxes all at once at the time of the conversion—the investor has additional time (up to two years) to pay conversion taxes when converting a traditional IRA to a Roth IRA.

The present invention involves the use of an annuity when converting a traditional IRA to a Roth IRA. An annuity is a financial contract in the form of an insurance product according to which the issuer—typically a financial institution—makes a series of payments in the future to the buyer (annuitant) in exchange for the immediate payment of a lump sum or a series of regular payments, prior to the onset of the annuity. The payment stream from the issuer to the annuitant has an unknown duration based principally upon the date of death of the annuitant. At this point the contract terminates unless there are other annuitants or beneficiaries in the contract, and the remainder of the fund accumulated is forfeited. Various forms of annuities exist.

A bonus annuity is an annuity that offers the investor a monetary bonus when the investor contributes a lump sum or a premium payment to the annuity. For example, if an investor contributes $10,000 into a bonus annuity, a $500 bonus may be added as a credit to the bonus annuity, thereby immediately increasing the amount of the account. Alternatively, a bonus annuity may provide a continuing bonus for every regular contribution made by the investor into the bonus annuity.

An indexed annuity is an annuity that earns interest linked to a stock or other index, such as the Standard & Poor's 500 Composite Stock Price Index. An indexed annuity is different from fixed annuities because of the way it credits interest to the annuity's value. Most fixed annuities only credit interest calculated at a rate set in the initial annuity contract. Indexed annuities credit interest using a formula based on changes in the index to which the annuity is linked. The formula decides how the additional interest, if any, is calculated and credited. A Bonus indexed annuity is an annuity that combines the benefits of a bonus annuity with that of an indexed annuity.

A guaranteed income rider is a financial product that can be combined with an annuity. A guaranteed income rider is a product that allows the investor to make regular withdrawals of a certain amount for life, while retaining access to principal. For example, if an investor deposits $100,000 in an annuity with a 5 percent guaranteed income rider, the investor can withdraw $5,000 annually for life, even when the account balance has been depleted. Alternatively, the investor can stop taking those withdrawals at any time and have access to any money remaining in the account. A bonus indexed annuity with a guaranteed income rider combines the benefits of a bonus annuity, an indexed annuity and a guaranteed income rider.

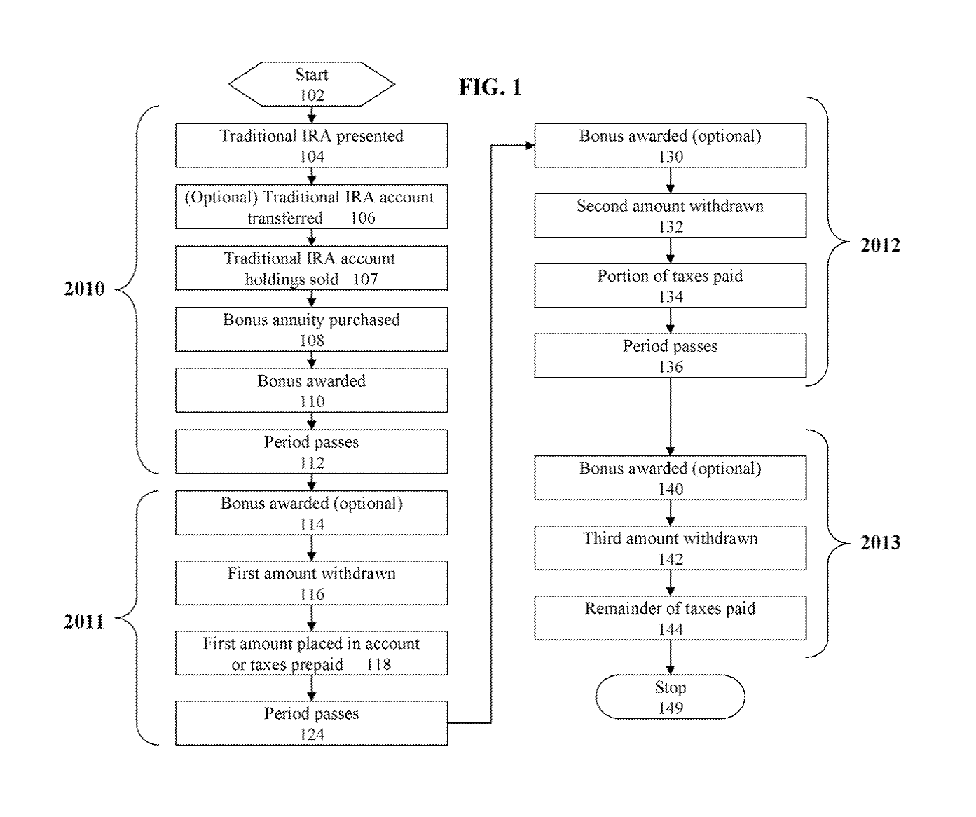

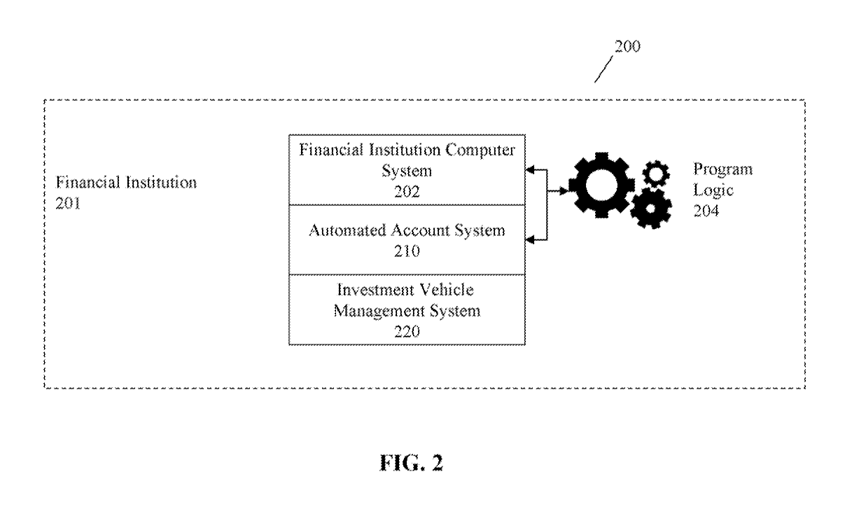

FIG. 1 is a flowchart showing the overall control flow of the traditional-to-Roth IRA conversion process in one embodiment of the present invention. Note that FIG. 1 is described in conjunction with FIG. 2, which is a block diagram describing an automated system 200 useful for implementing one embodiment of the present invention. The control flow of FIG. 1 begins with step 102 and moves immediately to step 104. In step 104, the investor presents his traditional IRA for conversion to a Roth IRA.

In optional step 106, if the traditional IRA account is currently located and administered by another financial institution, the traditional IRA account is transferred to the financial institution 201 that will perform the method of the present invention. Step 106 may be effectuated by having a standard account transfer form (either a paper form or an online soft copy equivalent) completed and submitted to the current financial institution. Step 106 may be executed, in whole or in part, by program logic 204 residing on server or computer system 202 of the financial institution 201 performing the process of the present invention. At the completion of step 106, the traditional IRA account is transferred to the financial institution 201 and available for access and modification by the automated account system 210 of the financial institution 201.

In step 107, the holdings of the traditional IRA are sold by the investment vehicle management system 220 of the automated account system 210 of the financial institution 201. In step 108, the investment vehicle management system 220 of the automated account system 210 uses the proceeds from the sale in step 107 to purchase a bonus annuity that is designated a Roth IRA account. In one alternative, the proceeds from the traditional IRA are used to purchase a bonus indexed annuity. In yet another alternative, the proceeds from the traditional IRA are used to purchase a bonus indexed annuity with a guaranteed income rider. Steps 107-108 may be executed, in whole or in part, by program logic 204 residing on server 202. Program logic 204 comprises computer source code, scripting language code or interpreted language code that is compiled to produce computer instructions that perform various functions of the present invention. In one embodiment of the present invention, the program logic 204 is a scripting language such as ECMAScript, Cascading style sheets, XML, XSLT, Javascript, AJAX, XUL, JSP, PHP, and ASP. Program logic 204 may reside on system 202, system 210 or any combination of the two. Alternatively, program logic 204 may exist in a distributed fashion wherein various components are located in various network-accessible locations.

In step 110, the purchase of the annuity in step 108 results in the award of a monetary bonus from the financial institution 201 from which the bonus annuity was purchased. Typically, the monetary bonus of step 110 is added to the principal of the annuity balance. In step 112, a time period, such as one year, passes.

In step 114, the Roth IRA may optionally experience another award of a monetary bonus from the financial institution 201. In step 116 a first amount of money is withdrawn from the annuity by automated account system 210 for the purposes of being used to pay the U.S. Internal Revenue Service the conversion taxes due for the conversion of the traditional IRA to a Roth IRA. In step 118 the withdrawn amount may be placed in a separate account designated for paying taxes on the conversion or the bonus amount may be withdrawn via a check or other instrument that is sent or transmitted to the investor. In step 118, the withdrawn amount may alternatively be used to pre-pay to the Internal Revenue Service the conversion taxes due for the conversion of the traditional IRA to a Roth IRA. Steps 114-118 may be executed, in whole or in part, by program logic 204 residing on server 202. In step 124, a time period, such as one year, passes.

In step 130, the Roth IRA may optionally experience another award of a monetary bonus from the financial institution 201. In step 132 (similar to steps 116-118), a fist amount of money withdrawn from the annuity and may be placed in an account slated for paying the IRA conversion taxes. In step 134, the monies withdrawn in steps 116 and 132 are used to pay at least a portion of the conversion taxes due for the conversion of the traditional IRA to a Roth IRA. Steps 130-134 may be executed, in whole or in part, by program logic 204 residing on server 202. In step 136, a time period, such as one year, passes.

In step 140, the Roth IRA may optionally experience another award of a monetary bonus from the financial institution 201. In step 142 (similar to steps 116-118 and step 132), a third amount of money is withdrawn from the annuity and may be placed in an account slated for paying the IRA conversion taxes. In step 144, the remaining monies withdrawn in steps 116, 132 and 142 are used to pay at least a portion of, or the entire remainder of, the conversion taxes due for the conversion of the traditional IRA to a Roth IRA. Steps 140-144 may be executed, in whole or in part, by program logic 204 residing on server 202. In step 144, the payment of all conversion taxes due to the conversion of the traditional IRA to a Roth IRA are substantially complete. In the event a residual amount of conversion taxes remains to be paid, the residual amount is paid by the investor from out-of-pocket funds. This may also be facilitated and executed by program logic 204 residing on server 202. In step 149 the control flow of FIG. 1 ceases.

Following is an example of the process shown in FIG. 1 using sample dollar figures and sample dates. In step 104, which occurs in the year 2010, a traditional IRA with a principal amount of $300,000 is presented. In step 108, a bonus annuity is purchased using the entire $300,000 principal. In step 110, a 15% bonus of $45,000 is awarded to the investor, which increases the bonus annuity balance to $345,000. In step 112, a period of one year passes. In step 116, which occurs in 2011, a first amount of $34,000 is withdrawn from the bonus annuity and placed in an account in step 118. In step 124, a period of one year passes. In step 132, which occurs in 2012, a second amount of $31,000 is withdrawn from the bonus annuity. In step 134, a portion (i.e., $42,000) of the taxes on the conversion is paid from the first and second amounts. This leaves a remainder of $23,000 from the first and second amounts. In step 136, a period of one year passes. In step 142, which occurs in 2013, a third amount of $19,000 is withdrawn from the bonus annuity. In step 144, a remainder (i.e., $42,000) of the taxes on the conversion is paid from the remainder of the first, second and third amounts. Note that the sum of the first, second and third amounts ($34K+$31K+$19K=$84K) is equal to the amount of taxes due and paid on the conversion ($84K). After the process above is completed, the remaining principal of the bonus annuity is estimated at $291,582 for an investor in the 28% tax bracket. Note that the remaining principal is significantly close in value to the principal of the original traditional IRA.

As the example above shows, all of the taxes on the conversion of the traditional IRA to a Roth IRA are paid from the bonus provided by the bonus annuity, as well as from earnings of the bonus annuity. The example above also shows that the present invention is advantageous because it allows the investor to significantly maintain the size of the principal of the IRA during conversion without requiring the investor to outlay significant out-of-pocket monies, thereby making the traditional-to-Roth conversion more palatable to the investor.

Various aspects of the present invention, can be realized in hardware, software, or a combination of hardware and software. A system according to a preferred embodiment of the present invention, such as the system of FIG. 2, can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

Various aspects of an embodiment of the present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following: a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allows a computer system to read such computer readable information.

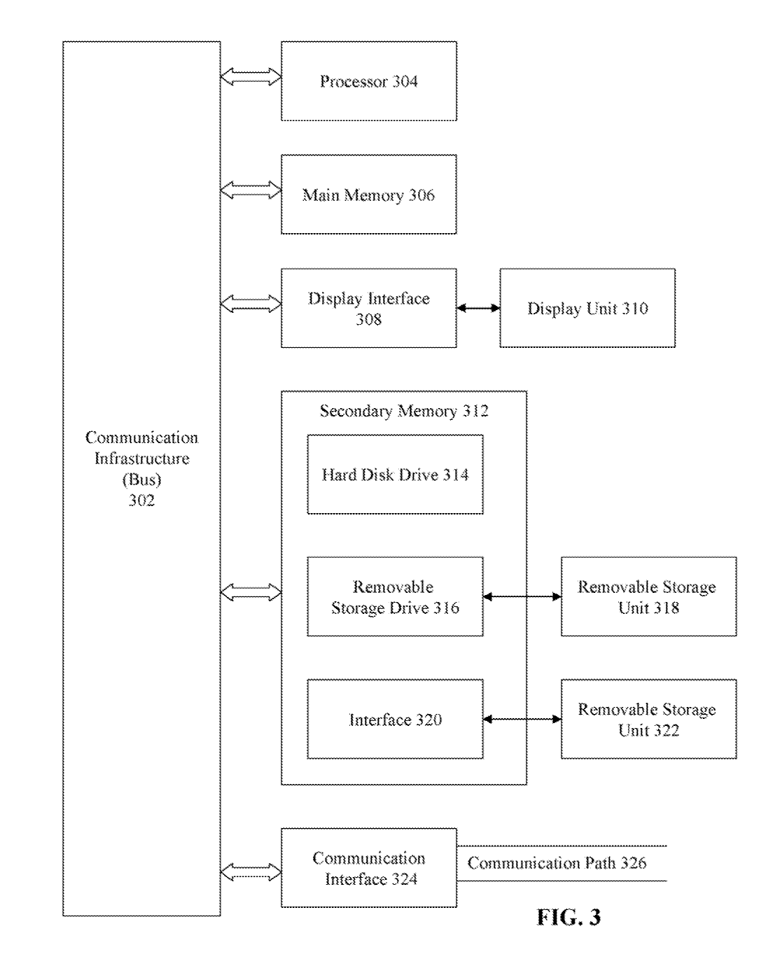

FIG. 3 is a high level block diagram showing an information processing system useful for implementing one embodiment of the present invention. The computer system includes one or more processors, such as processor 304. The processor 304 is connected to a communication infrastructure 302 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 308 that forwards graphics, text, and other data from the communication infrastructure 302 (or from a frame buffer not shown) for display on the display unit 310. The computer system also includes a main memory 306, preferably random access memory (RAM), and may also include a secondary memory 312. The secondary memory 312 may include, for example, a hard disk drive 314 and/or a removable storage drive 316, representing a floppy disk drive, a magnetic tape drive, an optical disk drive, etc. The removable storage drive 316 reads from and/or writes to a removable storage unit 318 in a manner well known to those having ordinary skill in the art. Removable storage unit 318, represents a floppy disk, a compact disc, magnetic tape, optical disk, etc. which is read by and written to by removable storage drive 316. As will be appreciated, the removable storage unit 318 includes a computer readable medium having stored therein computer software and/or data.

In alternative embodiments, the secondary memory 312 may include other similar means for allowing computer programs or other instructions to be loaded into the computer system. Such means may include, for example, a removable storage unit 322 and an interface 320. Examples of such may include a program cartridge and cartridge interface (such as that found in video game devices), a removable memory chip (such as an EPROM, or PROM) and associated socket, and other removable storage units 322 and interfaces 320 which allow software and data to be transferred from the removable storage unit 322 to the computer system.

The computer system may also include a communications interface 324. Communications interface 324 allows software and data to be transferred between the computer system and external devices. Examples of communications interface 324 may include a modem, a network interface (such as an Ethernet card), a communications port, a PCMCIA slot and card, etc. Software and data transferred via communications interface 324 are in the form of signals which may be, for example, electronic, electromagnetic, optical, or other signals capable of being received by communications interface 324. These signals are provided to communications interface 324 via a communications path (i.e., channel) 326. This channel 326 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 306 and secondary memory 312, removable storage drive 316, a hard disk installed in hard disk drive 314, and signals. These computer program products are means for providing software to the computer system. The computer readable medium allows the computer system to read data, instructions, messages or message packets, and other computer readable information from the computer readable medium.

Computer programs (also called computer control logic) are stored in main memory 306 and/or secondary memory 312. Computer programs may also be received via communications interface 324. Such computer programs, when executed, enable the computer system to perform the features of the present invention as discussed herein. In particular, the computer programs, when executed, enable the processor 304 to perform the features of the computer system. Accordingly, such computer programs represent controllers of the computer system.

What has been shown and discussed is a highly-simplified depiction of a programmable computer apparatus. Those skilled in the art will appreciate that other low-level components and connections are required in any practical application of a computer apparatus.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A method for defraying taxes on a conversion of a traditional individual retirement account (IRA) to a Roth IRA, comprising the steps of:
selling the holdings of the traditional IRA;
purchasing a bonus annuity with proceeds of the sale of the holdings;
designating the bonus annuity as a Roth IRA;
waiting for a period of time;
withdrawing from the bonus annuity a first amount slated for paying taxes on the conversion;
waiting for a period of time;
withdrawing from the bonus annuity a second amount;
paying at least a portion of taxes on the conversion with the first and second amounts;
waiting for a period of time;
withdrawing from the bonus annuity a third amount; and
paying substantially a remainder of the taxes on the conversion with a remaining portion of the first, second and third amounts, wherein a sum of the first, second and third amounts substantially equal the taxes on the conversion.

2. The method of claim 1, wherein the step of purchasing a bonus annuity further comprises purchasing a bonus indexed annuity with proceeds of the sale of the holdings.

3. The method of claim 2, wherein the step of purchasing a bonus annuity further comprises purchasing a bonus indexed annuity with a guaranteed income rider with proceeds of the sale of the holdings.

4. The method of claim 1, wherein the step of withdrawing from the bonus annuity a first amount further comprises:
withdrawing from the bonus annuity a first amount slated for paying taxes on the conversion; and
placing the first amount in a separate account designated for payment of taxes on the conversion.

5. The method of claim 4, wherein the step of withdrawing from the bonus annuity a second amount further comprises:
withdrawing from the bonus annuity a second amount; and
placing the second amount in the account designated for payment of taxes on the conversion.

6. The method of claim 5, wherein the step of withdrawing from the bonus annuity a third amount further comprises:
withdrawing from the bonus annuity a third amount; and
placing the third amount in the account designated for payment of taxes on the conversion.

7. The method of claim 6, wherein the steps of waiting for a period of time comprise:
waiting for a period of about one year.

8. A computer system for defraying taxes on a conversion of a traditional individual retirement account (IRA) to a Roth IRA, comprising a processor configured for:
selling the holdings of the traditional IRA;
purchasing a bonus annuity with proceeds of the sale of the holdings;
designating the bonus annuity as a Roth IRA;
waiting for a period of time;
withdrawing from the bonus annuity a first amount slated for paying taxes on the conversion;
waiting for a period of time;
withdrawing from the bonus annuity a second amount;
paying at least a portion of taxes on the conversion with the first and second amounts;
waiting for a period of time;
withdrawing from the bonus annuity a third amount; and
paying substantially a remainder of the taxes on the conversion with a remaining portion of the first, second and third amounts, wherein a sum of the first, second and third amounts substantially equal the taxes on the conversion.

9. The computer system of claim 8, wherein the step of purchasing a bonus annuity further comprises purchasing a bonus indexed annuity with proceeds of the sale of the holdings.

10. The computer system of claim 9, wherein the step of purchasing a bonus annuity further comprises purchasing a bonus indexed annuity with a guaranteed income rider with proceeds of the sale of the holdings.

11. The computer system of claim 10, wherein the steps of waiting for a period of time comprise:
waiting for a period of about one year.

12. A computer program product including computer instructions for defraying taxes on a conversion of a traditional individual retirement account (IRA) to a Roth IRA, the computer instructions including instructions for:
selling the holdings of the traditional IRA;
purchasing a bonus annuity with proceeds of the sale of the holdings;
designating the bonus annuity as a Roth IRA;
waiting for a period of time;
withdrawing from the bonus annuity a first amount slated for paying taxes on the conversion;
waiting for a period of time;
withdrawing from the bonus annuity a second amount;
paying at least a portion of taxes on the conversion with the first and second amounts;
waiting for a period of time;
withdrawing from the bonus annuity a third amount; and
paying substantially a remainder of the taxes on the conversion with a remaining portion of the first, second and third amounts, wherein a sum of the first, second and third amounts substantially equal the taxes on the conversion.

13. The computer program product of claim 12, wherein the instructions for purchasing a bonus annuity further comprise instructions for purchasing a bonus indexed annuity with proceeds of the sale of the holdings.

14. The computer program product of claim 13, wherein the instructions for purchasing a bonus annuity further comprise instructions for purchasing a bonus indexed annuity with a guaranteed income rider with proceeds of the sale of the holdings.

15. The computer program product of claim 12, wherein the instructions for withdrawing from the bonus annuity a first amount further comprise instructions for:
withdrawing from the bonus annuity a first amount slated for paying taxes on the conversion; and
placing the first bonus amount in a separate account designated for payment of taxes on the conversion.

16. The computer program product of claim 15, wherein the instructions for withdrawing from the bonus annuity a second amount further comprise instructions for:
withdrawing from the bonus annuity a second amount; and
placing the second amount in the account designated for payment of taxes on the conversion.

17. The computer program product of claim 16, wherein the instructions for withdrawing from the bonus annuity a third amount further comprise instructions for:
withdrawing from the bonus annuity a third amount; and
placing the third amount in the account designated for payment of taxes on the conversion.
